(19) United States
(12) Patent Application Publication
(10) Pub. No.: US 2012/0329484 A1
(43) Pub. Date: Dec. 27, 2012

(54) LOCATING MOBILE DEVICES UTILIZING WI-FI INFORMATION

(75) Inventor: Leigh M. Rothschild, Sunny Isles Beach, FL (US)

(73) Assignee: ARIEL INVENTIONS LLC, Sunny Isles Beach, FL (US)

(21) Appl. No.: 13/531,536

(22) Filed: Jun. 23, 2012

Related U.S. Application Data
(60) Provisional application No. 61/500,488, filed on Jun. 23, 2011.

(51) Int. Cl. H04W 24/00

(52) U.S. Cl. 455/456.5; 455/456.6

(57) ABSTRACT

Systems, methods and devices for locating a mobile device. This includes a mobile device receives a location message from a local computing device and identifies a location using a location application. Further, the mobile device receives one or more wireless signals, each wireless signal corresponding to a wireless router and identifies a relative strength for each wireless signal with respective to the mobile device. In addition, the mobile device receives wireless router identification information for each wireless router and sends the location and the wireless router identification information for each wireless router to the local computer device.

### CROSS-REFERENCE TO RELATED APPLICATIONS

The present application claims priority under the laws and rules of the United States, including 35 USC §120, to U.S. Provisional Patent Application No. 61/500,488 filed Jun. 23, 2011. The contents of U.S. Provisional Patent Application No. 61/500,488 filed Jun. 23, 2011 are herein incorporated by reference in its entirety.

### BACKGROUND

Mobile devices are frequently misplaced or lost thus users have need to locate these mobile devices. Further, users frequently have a need to know the mobile devices' locations to track users that are utilizing the mobile devices. For example, company managers may need to track employees' mobile devices for professional reasons. In addition, parents may want to track children's mobile device for personal and safety reasons. Currently, various device manufacturers including, but not limited to, Apple, Google (Android), and Research In Motion have applications (either by themselves or through a third party) to provide a mobile device location. An example of an Apple iPhone application that allows a user to track a device is the ATT Family Map location provided by ATT (e.g. third party). Another example of an Apple iPhone application is the Find Me (sometimes called Mobile Me) application provided by Apple.

The current mobile device location applications utilize cellular triangulation, or GPS technology (if the mobile device contains a Global Position System (GPS) locational feature) to determine the location of the mobile device. Such applications can inform a requesting user the approximate location of the mobile device. The preciseness of the location depends upon whether the mobile device contains a GPS feature, and the geographic area that the mobile device is located because cellular triangulation results vary depending upon the number of data points used in the triangulation. Typically, the estimate of the location of the mobile device using current applications vary from within a mile to more than five miles. Although such an estimate of mobile device location is valuable information for the requesting user, the present disclosure provides more precise or improved information on the location of the mobile device including an indication of the name of the location that the mobile device is located utilizing Wi-Fi—information supplied by the subject mobile device to locate the mobile device.

“Wi-Fi” is a term used to describe only a narrow range of connectivity technologies including wireless local area network (WLAN) based on the IEEE02.11 standards device to device connectivity (such as Wi-Fi Peer to Peer AKA Wi-Fi Direct), and a range of technologies that support PAN, LAN, and WAN connections. The technical term “IEEE 802.11” has been used interchangeably with Wi-Fi, but over the past few years Wi-Fi has become a superset communication networks that use the IEEE 802.11 family of standards.

The term Wi-Fi Hotspot is derived from the term Wi-Fi. Further, a Wi-Fi hotspot can be a public place that connects a computing device (e.g. smartphone, tablet computer, laptop computer, etc.) wirelessly to the Internet. A Wi-Fi hotspot may refer to the area covered by the Wi-Fi communication network. These hotspots, which can be found in airports, coffee bars, bookshops, and college campuses, use one or more wireless routers to generate a wireless (e.g. Wi-Fi) network to provide access to the Internet. Coffee shops, hotels or airports install a wireless router with Internet access for generating Wi-Fi communication networks for public use. In many cases such access is free, though some Wi-Fi hotspots operators may require users pay for access.

With respect to Wi-Fi hotspots, the wireless router generating the WiFi communication network provide wireless connectivity to the Internet. A wireless router serves two purposes. First, the wireless router provides connectivity to computing devices connected to the wireless router. Second, the wireless router provides the connected computing devices with Internet access. A wireless router provides such connectivity to the computing devices wirelessly without requiring the computers to be physically connected to the wireless router or to each other.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the present disclosure is not limited to the precise arrangements and instrumentalities shown, wherein:

FIG. 1 is an exemplary network of devices used for locating a remote mobile device;

FIG. 2 is a functional block diagram of an exemplary remote mobile device;

FIG. 3 is a functional block diagram of an exemplary local computer;

FIG. 4 is an exemplary flowchart of an example method for locating a remote mobile device; and

FIG. 5 is an exemplary flowchart of an example method for locating a remote mobile device.

### DETAILED DESCRIPTION

Embodiments of the present disclosure include systems, devices, and methods for locating a remote mobile device by user. Application for locating such a remote mobile device may include, but not limited to, the owner is locating a lost remote mobile device, an employer locating an employee remote mobile device, or a parent monitoring the location of a child's remote mobile device. The user accesses a location software application on a local computer and provides identification information regarding the remote mobile device. The software application causes a remote computer server to contact the remote mobile device over a wireless network. Further, the remote computer server queries the remote mobile device for location information. Consequently, the remote mobile device determines a location using a location application and a Global Positioning System (GPS) incorporated into the remote mobile device. In addition, the remote mobile device detects one or more wireless routers that are in proximity. Moreover, the remote mobile device queries and receives wireless router information from the wireless routers and determines the location of the wireless routers. Further, the remote mobile device sends the local computer the location of the remote mobile device and the wireless routers.

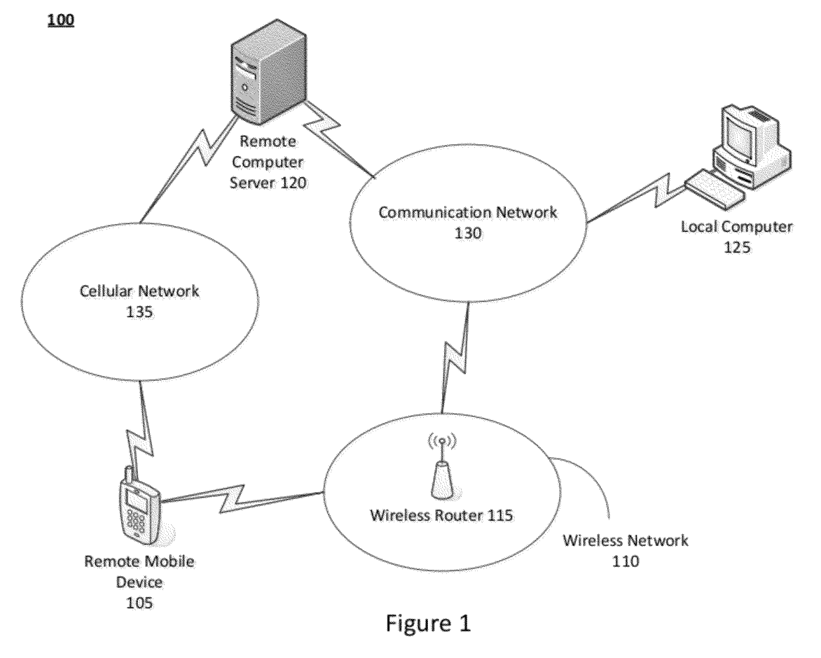

FIG. 1 is an exemplary network 100 of devices used for locating a remote mobile device. The network 100 includes a remote mobile device 105 coupled to a wireless network 110 generated by a wireless router 115. Further, the wireless router 115 is coupled to a communication network 130 such as the Internet. In addition, a remote computer server 120 and a local computer 125 are coupled to the each other and the wireless router 115 across the Internet. Moreover, the remote computer 120 is coupled to the remote mobile device 105 across a cellular network 135.

A user of the remote mobile device 105 accesses a location software application on the local computer 125 and provides identification information regarding the remote mobile device 105 to the remote computer server 120. The remote computer 120 may be owned and operated by a cellular service provider or a third party authorized by the cellular service provider to access the cellular network 135. The software application causes the remote computer server 120 to determine the location of the remote mobile device 105.

In one embodiment, the remote computer server 120 communicates with one or more base stations in the cellular network 135, and the operator of the remote computer server 120 uses triangulation to determine the location of the remote mobile device 105. The one or more base stations provide the triangulation information to the remote computer server 120 that processes the triangulation information and determines the location of the remote mobile device 105. The remote computer server 120 sends the location of the remote mobile device 105 to the local computer 125 to inform the user.

In an alternate embodiment, the remote computer server 120 queries the remote mobile device 105 for location information. Consequently, the remote mobile device 105 determines its location by communicating with one or more base stations in the cellular network 135. Further, the one or more base stations use triangulation to determine the location of the remote mobile device 105. The one or more base stations provide the triangulation information to the remote mobile device 105, which processes the triangulation information using a location application and determines its location. Further, the remote mobile device 105 sends its location to the remote computer server 120, which then sends the location of the remote mobile device 105 to the local computer 125 to inform the user. Alternatively, the remote mobile device 105 can send its location to the local computer 125, directly. In such an embodiment, the remote mobile device 105 is given the address of the local computer 125 by the remote computer server 120.

In addition, the remote mobile device 105 detects one or more wireless routers that are in its proximity. Moreover, the remote mobile device 105 queries and receives wireless router information from the wireless routers and determines the location of the wireless routers. Further, the remote mobile device sends the local computer 125 the location of the remote mobile device and the wireless routers, either directly or through the remote computer server 120.

Although the user uses a local computer 125 to locate the remote mobile device 105, alternative embodiments such as an employee locating an employee remote mobile device or a parent locating an child' remote mobile device may use a software application on a different mobile device to locate the remote mobile device.

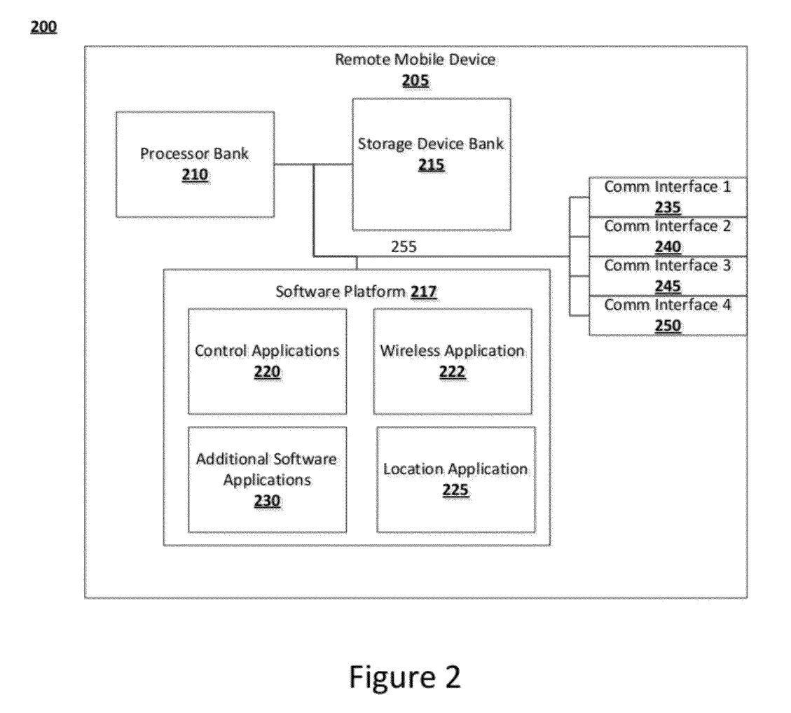

FIG. 2 is a functional block diagram 200 of an exemplary remote mobile device 205. Such a remote mobile device 205 may include several components, such as a processor bank 210, a storage device bank 215, a software platform 217, and one or more communication interfaces (235-250).

The processor bank 210 may include one or more processors that may be co-located with each other or may be located in different parts of the remote mobile device 205. The storage device bank 215 may include one or more storage devices. Types of storage devices may include memory devices, electronic memory, optical memory, and removable storage media.

The one or more software applications 217 may include control applications 220, a wireless application 222, a location application 225, and additional software applications 230. Further, the location application 225 determines the location of the remote mobile device 205. In one embodiment, the location application 225 receives triangulation information from one or more cellular base stations. The location application 225 processes the triangulation information and determines the location of the remote mobile device 205 based on the triangulation information. In another embodiment, the location application 225 includes GPS features such that the location application 225 can determines the location of the remote mobile device.

In addition, the wireless application 222 assists in performing certain tasks for the remote mobile device 205, such as providing access to a communication network (e.g., wired, wireless, Bluetooth, infra-red, RF, etc.) by providing a user name and password or a security key to access a communication network. Further, wireless application 222 detects one or more wireless routers, each generating a wireless network, by receiving a signal from each wireless router. Moreover, the wireless application 222 may then receive wireless router identification information (e.g., wireless network name, etc.) and associated wireless router information (e.g., operator information) provided by an operator of the wireless router that generates the wireless network.

In one embodiment, the location application 225 receives and processes the wireless router information and the operator information. Such processing includes submitting the location of the remote mobile device 205 based on the triangulation and the wireless router identification to a mapping database (e.g. Mapquest, Google, Maps, etc.) that determines a wireless router location. Further, the location application 225 receives the wireless router location from the mapping database. In another embodiment, the location application 225 submits the location of the remote mobile device 205 based on the triangulation and the wireless router identification to search engine (e.g. Google, Bing etc.) that determines a wireless router location. Further, the location application 225 receives the wireless router location from the search engine. Moreover, the location application 225 sends to the local computer 125 the location of the remote mobile device 205 based on triangulation, the wireless router location, wireless router identification information and/or the associated wireless router information.

Control applications 220 and additional software applications 230 may include functions such as executing an operating system, managing software drivers for peripheral components, and processing information. In addition, the additional and control applications (220 and 230) may also include software drivers for peripheral components, user interface computer programs, debugging and troubleshooting software tools. Also, the control and additional software applications (220 and 230) may include an operating system known in the art (e.g. Windows 7, Linux, UNIX, previous version of Windows and MacOS, etc.).

Each of the communication interfaces (235-250) shown in FIG. 2 may be software or hardware associated in communicating to other devices. The communication interfaces (235-250) may be of different types that include a user interface, USB, Ethernet, WiFi, WiMax, wireless, optical, cellular, or any other communication interface coupled to communication network.

An intra-device communication link 255, between the processor bank 210, storage device bank 215, software applications 217, and communication interfaces (235-250), may be one of several types that include a bus or other communication mechanism.

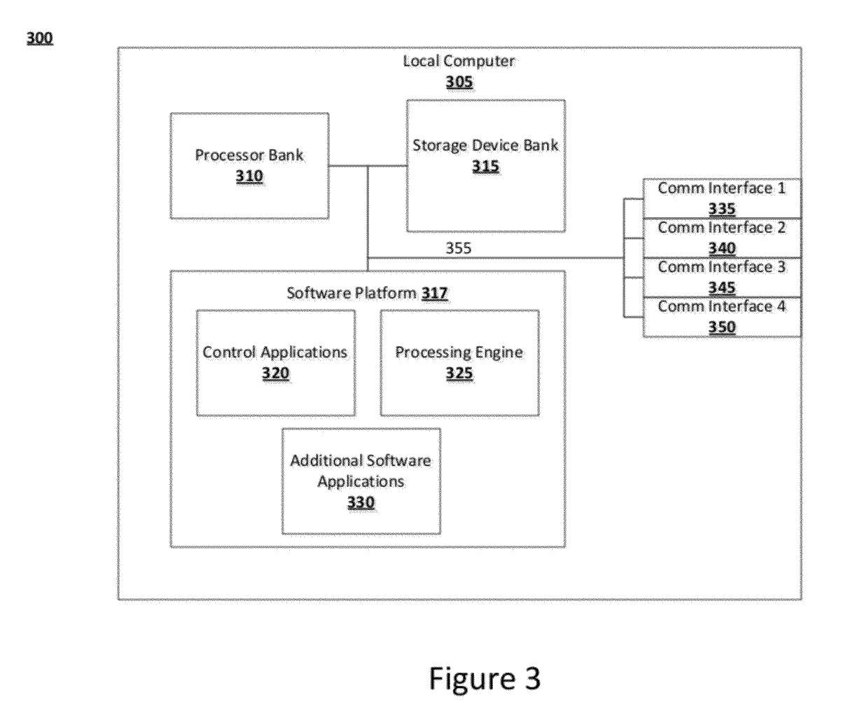

FIG. 3 is a functional block diagram 300 of an exemplary local computer 305. Such a local computer 305 may include several components such as a processor bank 310, storage device bank 315, a software platform 317, and one or more communication interfaces (335-350).

The processor bank 310 may include one or more processors that may be co-located with each other or may be located in different parts of the operator broadcasting system 305. The storage device bank 315 may include one or more storage devices. Types of storage devices may include memory devices, electronic memory, optical memory, and removable storage media.

The one or more software platform 317 may include control applications 320, processing engine 325 and additional software applications 330. A user of the local computer 305 may input instructions through a user interface (e.g. web browser, etc.) to locate a lost remote mobile device. The processing engine 325 receives the instructions and sends a query signal to the lost remote mobile device requesting a location of the remote mobile device. Further, the processing engine 315 receives a location of the remote mobile device based on triangulation or GPS data and wireless router identification information for each wireless router in proximity of the lost remote mobile device. In addition, the processing engine 325 receives associated wireless router information for each wireless in proximity of the mobile device. The associated wireless router information can be textual information, graphic information, mapping information, and a combination thereof such as a street address, map, etc. Moreover, the processing engine 325 receives a relative strength for each wireless signal corresponding to each wireless router with respective to the mobile device.

Further, the processing engine 325 presents the location of the remote mobile device and wireless router identification information for each wireless router on a display of the local computer 305. In addition, the processing engine 325 may submit the wireless router identification information to a mapping database or search engine. Further, the processing engine 325 receives one or more wireless router locations for each wireless router in proximity of the mobile device based on the submitted wireless router identification information. In addition, the processing engine 325 presents the one or more wireless router locations for each wireless router on the display of the local computer 305. Moreover, the processing engine 325 presents the associated wireless router information on the display of the local computer 305. The processing engine 325 also processes and presents the relative strength of each of the wireless routers. The user would understand that the wireless router with more relative strength would likely be closer to the lost remote mobile device.

The control and additional software applications (320 and 330) may include applications that assist in performing certain tasks for the operator broadcasting system 305, such as providing access to a communication link (e.g., wired, wireless, Bluetooth, infra-red, RF, etc.), executing an operating system, managing software drivers for peripheral components, and processing information. In addition, the control and additional software applications (320 and 330) may also include software drivers for peripheral components, user interface computer programs, debugging and troubleshooting software tools. Also, the control and additional software applications (320 and 330) may include an operating system known in the art (e.g. Windows 7, Linux, UNIX, previous version of Windows and MacOS, etc.).

Each of the communication interfaces (335-350) shown in FIG. 3 may be software or hardware associated in communicating to other devices. The communication interfaces (335-350) may be of different types that include a user interface, USB, Ethernet, WiFi, WiMax, wireless, optical, cellular, or any other communication interface coupled to communication network.

An intra-device communication link 355 is provided between the processor bank 310, storage device bank 315, software applications 317, and communication interfaces (335-350), and the intra-device communication link 355 may be one of several types that include a bus or other communication mechanism.

The local computer 305 may be a desktop computer but can also be a mobile phone, smartphone, tablet computer, notebook computer, laptop computer, or any other computing device known in the art.

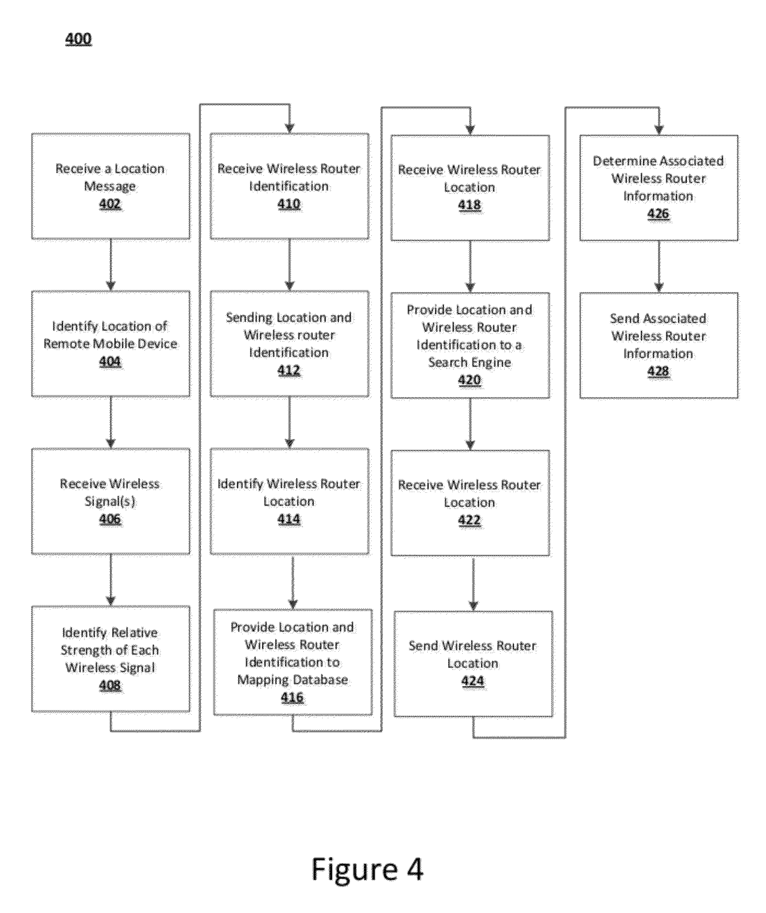

FIG. 4 is an exemplary flowchart of an example method 400 for locating a remote mobile device. The method 400 includes the remote mobile device receiving a location message from a local computing device, as shown in block 402. The method further includes identifying a location using a location application, as shown in block 404. The method additionally includes receiving one or more wireless signals, each wireless signal corresponding to a wireless router, as shown in block 406. Moreover, the method includes identifying a relative strength for each wireless signal with respective to the remote mobile device, as shown in block 408. The method further includes receiving wireless router identification information for each wireless router, as shown in block 410. The method additionally includes sending the location and the wireless router identification information for each wireless router to the local computer, as shown in block 412.

Moreover, the method includes identifying one or more wireless router locations using the location application based on the wireless router identification information for each wireless router, as shown in block 414. The method further includes providing the location and wireless router identification information for each wireless router to a mapping database, as shown in block 416. The method additionally includes receiving one or more wireless router locations using the location application based on the wireless router identification information for each wireless router, as shown in block 418. Moreover, the method includes providing the location and wireless router identification information for each wireless router to a search engine, as shown in block 420. The method further includes receiving one or more wireless router locations using the location application based on the wireless router identification information for each wireless router, as shown in block 422. The method additionally includes sending the one or more wireless router locations to the local computer, as shown in block 424.

Moreover, the method includes determining associated wireless router information for each wireless router, as shown in block 426. The method further includes sending the associated wireless router information for each wireless router to the local computer, as shown in block 428. The associated wireless router information can be textual information, graphic information, mapping information, and/or a combination thereof.

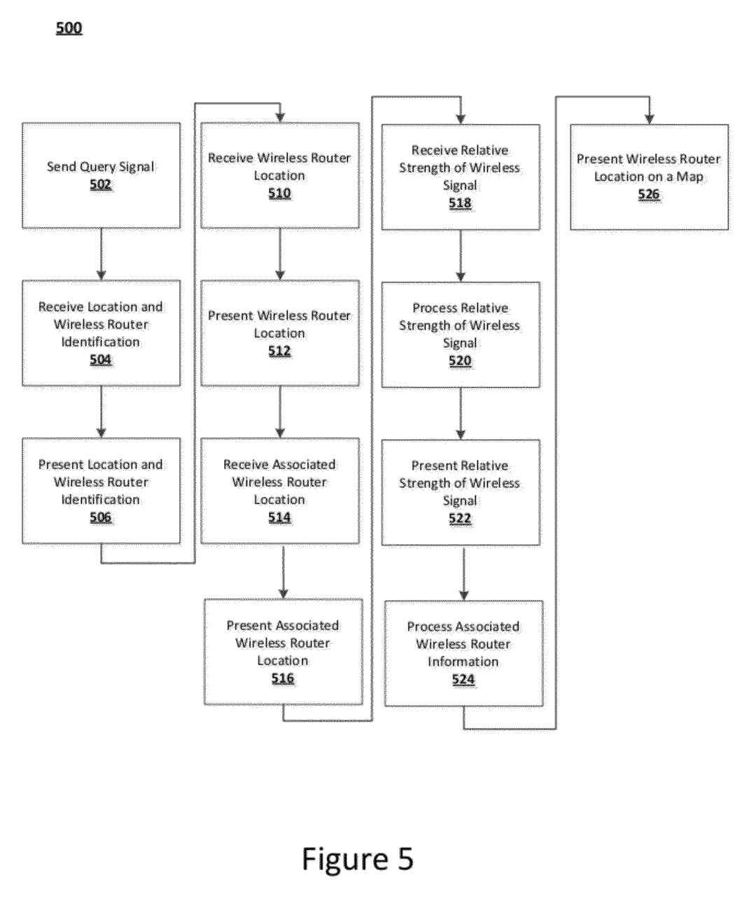

FIG. 5 is an exemplary flowchart of a method 500 for locating a remote mobile device. The method 500 includes sending a query signal to a mobile device, the query signal requesting a location of the mobile device, as shown in block 502. The method further includes receiving a location of the mobile device and wireless router identification information for each wireless router in proximity of the mobile device, as shown in block 504. The method additionally includes presenting the location of the mobile device and wireless router identification information for each wireless router on a display of the local computing device, as shown in block 506.

Moreover, the method includes receiving one or more wireless router locations for each wireless router in proximity of the mobile device, as shown in block 510. The method further includes presenting the one or more wireless router locations for each wireless router on the display of the local computing device, as shown in block 512. The method additionally includes receiving associated wireless router information for each wireless in proximity of the mobile device, as shown in block 514. Moreover, the method includes presenting associated wireless router information for each wireless in proximity of the mobile device, as shown in block 516. The associated wireless router information can be textual information, graphic information, mapping information, and/or a combination thereof.

The method includes receiving a relative strength for each wireless signal corresponding to each wireless router with respective to the mobile device, as shown in block 518. The method further includes processing the relative strength for each wireless signal and presenting the relative strength for each wireless signal corresponding to each wireless router with respective to the mobile device, as shown in block 520 and 522, respectively. The method additionally includes processing the associated wireless router information for each wireless router in proximity of the mobile device, as shown in block 524. Moreover, the method includes presenting each wireless router location on a map based on the associated wireless router information for each wireless router, as shown in block 526.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for locating a mobile device, comprising:
receiving a location message from a local computing device;
identifying a location using a location application;
receiving one or more wireless signals, each wireless signal corresponding to a wireless router;
identifying a relative strength for each wireless signal with respective to the mobile device;
receiving wireless router identification information for each wireless router; and
sending the location and the wireless router identification information for each wireless router to the local computer device.

2. The method of claim 1, further comprising identifying one or more wireless router locations using the location application based on the wireless router identification information for each wireless router.

3. The method of claim 1, further comprising:
providing the location and wireless router identification information for each wireless router to a mapping database; and
receiving one or more wireless router locations using the location application based on the wireless router identification information for each wireless router.

4. The method of claim 1, further comprising:
providing the location and wireless router identification information for each wireless router to a search engine; and
receiving one or more wireless router locations using the location application based on the wireless router identification information for each wireless router.

5. The method of claim 2, further comprising sending the one or more wireless router locations to the local computer device.

6. The method of claim 1, further comprising:
determining associated wireless router information for each wireless router; and
sending the associated wireless router information for each wireless router to the local computer device.

7. The method of claim 1, wherein the associated wireless router information can be selected from the group consisting of textual information, graphic information, mapping information, and a combination thereof.

8. A mobile device for locating a mobile device, comprising:
at least one processor configured to initiate or perform:
receiving a location message from a local computing device;
identifying a location using a location application;
receiving one or more wireless signals, each wireless signal corresponding to a wireless router;
identifying a relative strength for each wireless signal with respective to the mobile device;
receiving wireless router identification information for each wireless router; and
sending the location and the wireless router identification information for each wireless router to the local computer device.

9. The mobile device of claim 8, wherein the at least one processor is further configured to initiate or perform identifying one or more wireless router locations using the location application based on the wireless router identification information for each wireless router.

10. The mobile device of claim 8, wherein:
the at least one processor is further configured to initiate or perform:
providing the location and wireless router identification information for each wireless router to a mapping database; and
receiving one or more wireless router locations using the location application based on the wireless router identification information for each wireless router.

11. The mobile device of claim 8, wherein:
the at least one processor is further configured to initiate or perform:
providing the location and wireless router identification information for each wireless router to a search engine; and
receiving one or more wireless router locations using the location application based on the wireless router identification information for each wireless router.

12. The mobile device of claim 9, wherein the at least one processor is further configured to initiate or perform sending the one or more wireless router locations to the local computer device.

13. The mobile device of claim 8, wherein:
the at least one processor is further configured to initiate or perform:
determining associated wireless router information for each wireless router; and
sending the associated wireless router information for each wireless router to the local computer device.

14. The mobile device of claim 8, wherein the associated wireless router information can be selected from the group consisting of textual information, graphic information, mapping information, and a combination thereof.

15. A local computing device for locating a mobile device, comprising:
at least one processor configured to initiate or perform:
sending a query signal to a mobile device, the query signal requesting a location of the mobile device;
receiving a location of the mobile device and wireless router identification information for each wireless router in proximity of the mobile device; and
presenting the location of the mobile device and wireless router identification information for each wireless router on a display of the local computing device.

16. The local computing device if claim 15, wherein:
the at least one processor is further configured to initiate or perform:
receiving one or more wireless router locations for each wireless router in proximity of the mobile device; and
presenting the one or more wireless router locations for each wireless router on the display of the local computing device.

17. The local computing device if claim 15, wherein:
the at least one processor is further configured to initiate or perform:
receiving associated wireless router information for each wireless in proximity of the mobile device; and
presenting associated wireless router information for each wireless in proximity of the mobile device.

18. The local computing device if claim 15, wherein:
the at least one processor is further configured to initiate or perform:
receiving a relative strength for each wireless signal corresponding to each wireless router with respective to the mobile device;
processing the relative strength for each wireless signal;
presenting the relative strength for each wireless signal corresponding to each wireless router with respective to the mobile device.

19. The local computing device if claim 15, wherein the associated wireless router information can be selected from the group consisting of textual information, graphic information, mapping information, and a combination thereof.

20. The local computing device if claim 19, wherein:
the at least one processor is further configured to initiate or perform:
processing the associated wireless router information for each wireless router in proximity of the mobile device; and
presenting each wireless router location on a map based on the associated wireless router information for each wireless router.
